(19) United States
(12) Patent Application Publication
(10) Pub. No.: US 2023/0327254 A1
(43) Pub. Date: Oct. 12, 2023

(54) BATTERY MODULE AND BATTERY PACK INCLUDING THE SAME

(71) Applicant: LG Energy Solution, Ltd., Seoul (KR)

(72) Inventors: Kwangmo Kim, Daejeon (KR); Junyeob Seong, Daejeon (KR); Hyemi Jung, Daejeon (KR)

(21) Appl. No.: 18/007,682

(22) PCT Filed: Aug. 31, 2021
(86) PCT No.: PCT/KR2021/011698

§ 371 Date: Jun. 28, 2023

(30) Foreign Application Priority Data
Aug. 31, 2020 (KR) 10-2020-0110448
Aug. 30, 2021 (KR) 10-2021-0114614

(51) Int. Cl. H01M 50/211; H01M 50/24; H01M 50/383

(52) U.S. Cl. CPC H01M 50/211; H01M 50/383; H01M 50/24

(57) ABSTRACT

A battery module including: a battery cell stack including a plurality of battery cells, each of the battery cells including an electrode assembly, are stacked; a housing accommodating the battery cell stack; and at least one flame-retardant pad interposed between at least one pair of adjacent battery cells among the plurality of battery cells or between the battery cell stack and the housing, in which an area of the flame-retardant pad is equal to or larger than an area of the electrode assembly.

### CROSS-REFERENCE TO RELATED APPLICATION(S)

This application is a US national phase of international Application No. PCT/KR2021/011698 filed Aug. 31, 2021, and claims the benefit of priority based on Korean Patent Applications No. 10-2020-0110448 filed Aug. 31, 2020, and No. 10-2021-0114614 filed Aug. 30, 2021, the contents of which are incorporated as if fully set forth herein.

### TECHNICAL FIELD

The present invention relates to a battery module and a battery pack including the same, and more particularly, to a battery module having improved safety by delaying or blocking transfer of heat between cells, and a battery pack including the same.

### BACKGROUND

Secondary batteries that are easy to use with various product groups and have electrical characteristics such as high energy density have been generally applied to not only portable devices, but also electric vehicles, hybrid vehicles, or power storage devices which are driven by an electric drive source. These secondary batteries are attracting attention as a new energy source for improving eco-friendliness and energy efficiency in that the use of fossil fuels may be dramatically reduced and no by-products may be generated from the use of energy.

One to three battery cells are used per device in small mobile devices, but high-output and high-capacity battery cells are required for medium and large devices such as automobiles. Accordingly, a medium and large battery module in which a plurality of battery cells are electrically connected has been used.

Since it is preferable that the medium and large battery module should be manufactured in a lightweight and thin structure if possible, a prismatic battery, a pouch-type battery, etc. that may be stacked with a high degree of integration and have a small weight and high capacity have been mainly used as battery cells of the medium and large battery module. The battery module includes a frame member for accommodating a battery cell stack in an internal space thereof while covering top, bottom, left, and right surfaces of the battery cell stack to protect the cell stack from external impact, heat, or vibrations.

As described above, since the plurality of battery cells included in the battery module are stacked, when problems such as thermal runaway occur in any one of the battery cells, heat and flame generated from the cell may easily transfer to adjacent battery cells.

### SUMMARY

The present invention has been made in an effort to provide a battery module and a battery pack including the same having advantages of suppressing a chain combustion reaction by delaying or blocking transfer of heat to adjacent battery cells even if a problem such as thermal runaway occurs in any one of the battery cells inside the battery module.

However, problems to be solved by exemplary embodiments of the present invention are not limited to the abovementioned problems, and can be variously expanded within the scope of the technical idea included in the present invention.

An exemplary embodiment of the present invention provides a battery module including: a battery cell stack in which a plurality of battery cells each including an electrode assembly are stacked; a housing accommodating the battery cell stack; and at least one flame-retardant pad interposed between at least one pair of adjacent battery cells among the plurality of battery cells or between the battery cell stack and the housing, in which an area of the flame-retardant pad is equal to or larger than that of the electrode assembly.

At least two or more of the flame-retardant pads may be provided, and at least one battery cell may be positioned between two adjacent flame-retardant pads among the flame-retardant pads.

A spacing between the flame-retardant pads may be the same or different.

The flame-retardant pad may include a silicone foam pad.

The flame-retardant pad may include two silicone foam pads and a mica sheet interposed between the two silicone foam pads.

The battery module may further include a coating film formed on one surface of the silicone foam pad.

The coating film may include at least one of polyethylene terephthalate (PET), polyvinyl chloride (PVC), polypropylene (PP), and polycarbonate (PC).

A fine pattern may be formed on a surface of the silicone foam pad.

The silicone foam pad may further include an inorganic refractory filler filling pores therein.

The inorganic refractory filler may include at least one of calcium carbonate (CaCO₃), mica, glass fiber, and mineral fiber composite.

The silicone foam pad may further include an extinguishing agent that fills the pores therein.

The extinguishing agent may be at least one selected from the group consisting of inorganic carbonates, inorganic phosphates, and inorganic sulfates.

The silicone foam pad may further include a flame-retardant filler filling the pores therein.

The flame-retardant filler may be at least one selected from the group consisting of nano-bismuth oxide, aluminum oxide nano-powder, and organic nano-clay.

An area of the flame-retardant pad may be equal to or larger than that of a negative electrode of the electrode assembly.

The flame-retardant pad may not overlap a portion where electrode leads coupled to the electrode assembly are disposed.

The silicone foam pad may not contain a halogen element.

The flame-retardant pad may further include at least one thermal insulation-flame retarded member formed on at least one surface of the silicone foam pad.

The thermal insulation-flame retarded member may be at least one selected from the group consisting of glass fiber reinforced pad and carbon fiber reinforced pad.

The silicone foam pad may include at least one first silicone foam pad and at least one second silicone foam pad, and the density of the first silicone foam pad may be higher than the density of the second silicone foam pad.

The silicone foam pad may include one of the first silicone foam pad, and two of the second silicone foam pads disposed on both sides of the first silicone foam pads.

The silicone foam pad may include one of the second silicone foam pad, and two of the first silicone foam pads disposed on both sides of the second silicone foam pads.

The flame-retardant may further include at least one foam coating layer formed on at least one surface of the silicone foam pad.

The foam coating layer may expand as the surrounding temperature rises.

Another exemplary embodiment of the present invention provides a battery pack including: the at least one battery module described above; and a pack case packaging the at least one battery module.

According to exemplary embodiments, by including a flame-retardant pad between battery cells, even if a problem such as thermal runaway occurs in any one battery cell inside the battery module, it is possible to delay or block transfer of heat and flame to adjacent battery cells and improve safety of the module by suppressing a chain combustion reaction.

### BRIEF DESCRIPTION OF THE DRAWINGS

FIG. 1 is a perspective view of a battery module according to an exemplary embodiment of the present invention.

FIGS. 2A and 2B are cross-sectional views along line A-A′ of FIG. 1.

FIG. 3 is a perspective view of one battery cell included in a battery cell stack of FIG. 1.

FIG. 4 is a cross-sectional view of the battery cell of FIG. 3 and a cross-sectional view of a flame-retardant pad along line B-B′ of FIG. 3.

FIG. 5 is a top view of the battery cell and the flame-retardant pad of FIG. 4.

FIG. 6 is an enlarged view of portion C of FIG. 5.

FIG. 7 is a graph illustrating results of a thermal runaway experiment according to an example and a comparative example.

FIG. 8 is an illustration of a flame-retardant pad according to a second embodiment of the present invention.

FIG. 9 is an illustration of a flame-retardant pad according to a third embodiment of the present invention.

FIG. 10 to FIG. 13 are illustrations of flame-retardant pads according to fourth to seventh embodiments of the present invention.

### DETAILED DESCRIPTION

Hereinafter, several exemplary embodiments of the present invention will be described in detail with reference to the accompanying drawings so that those skilled in the art to which the present invention pertains may easily practice the present invention. However, the present invention may be implemented in various different forms and is not limited to exemplary embodiments provided herein.

Portions unrelated to the description will be omitted in order to obviously describe the present invention, and similar components will be denoted by the same or similar reference numerals throughout the present specification.

In addition, since sizes and thicknesses of the respective components illustrated in the drawings are arbitrarily illustrated for convenience of explanation, the present invention is not necessarily limited to those illustrated in the drawings. In the drawings, the thickness of layers, films, panels, regions, etc., are exaggerated for clarity. In addition, in the accompanying drawings, thicknesses of some of layers and regions have been exaggerated for convenience of explanation.

In addition, it will be understood that when an element such as a layer, film, region, or substrate is referred to as being “on” another element, it can be directly on the other element or intervening elements may also be present. In contrast, when an element is referred to as being “directly on” another element, there are no intervening elements present. In addition, the fact that an element is positioned “above” or “on” a reference element means that it is positioned above or below the reference element, and is not necessarily means that is positioned “above” or “on” in an opposite direction to gravity.

In addition, unless explicitly described to the contrary, the word “comprise”, and variations such as “comprises” or “comprising”, will be understood to imply the inclusion of stated elements but not the exclusion of any other elements.

Further, throughout the specification, the word “plan view” refers to a view when a target is viewed from the top, and the word “cross-sectional view” refers to a view when a cross section of a target taken along a vertical direction is viewed from the side.

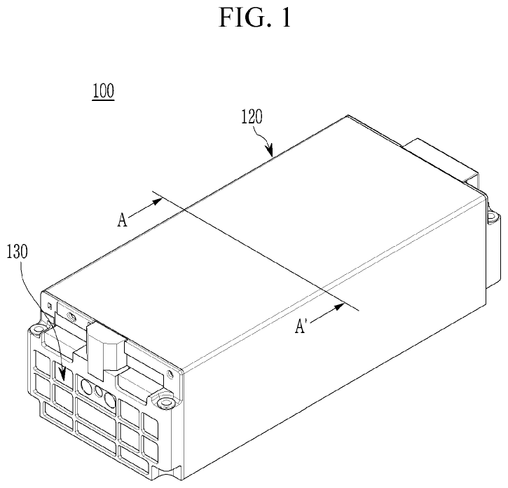

Hereinafter, a battery module according to an exemplary embodiment of the present invention will be described with reference to FIGS. 1 to 6.

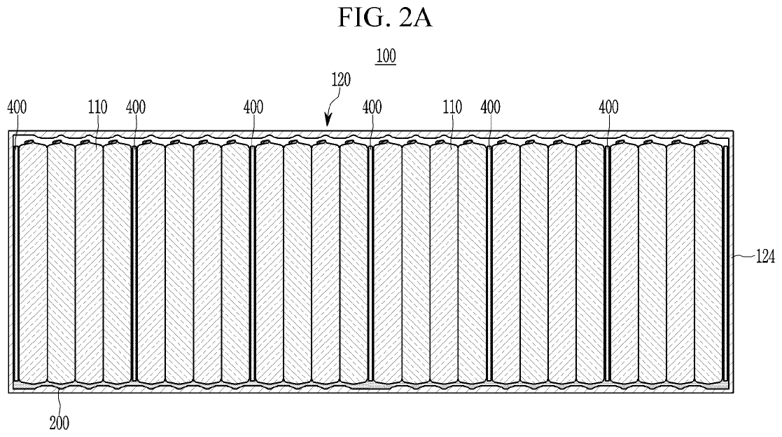

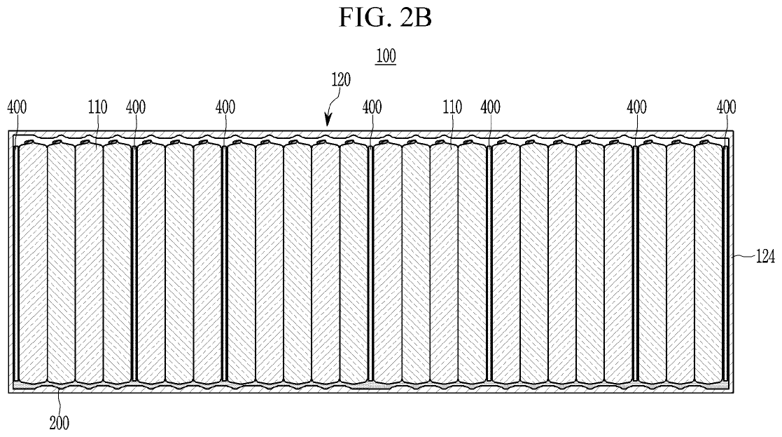

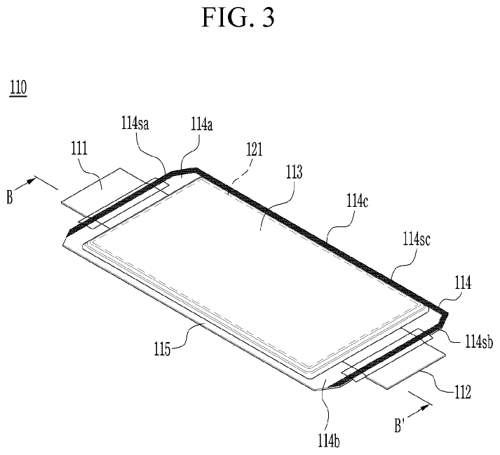

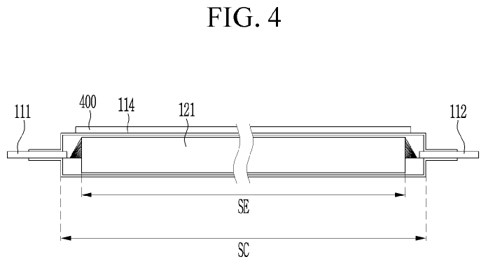

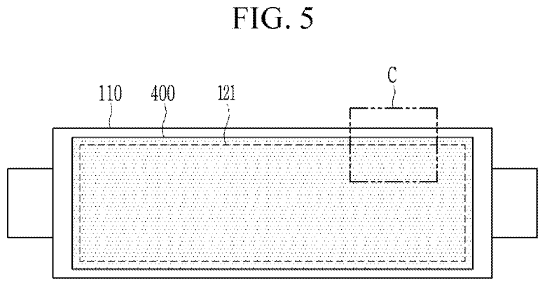

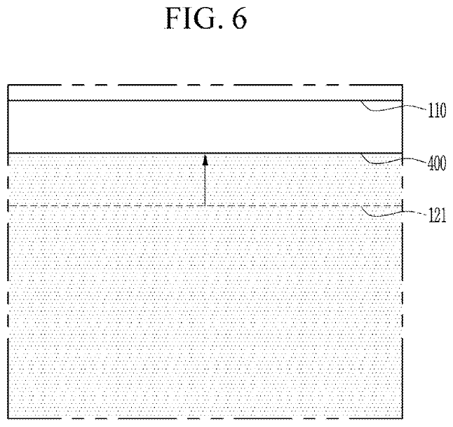

FIG. 1 is a perspective view of a battery module according to an exemplary embodiment of the present invention, FIGS. 2A and 2B are cross-sectional views along line A-A′ of FIG. 1, FIG. 3 is a perspective view of one battery cell included in a battery cell stack of FIG. 1, FIG. 4 is a cross-sectional view of the battery cell of FIG. 3 and a cross-sectional view of a flame-retardant pad along line B-B′ of FIG. 3, FIG. 5 is a top view of the battery cell and the flame-retardant pad of FIG. 4, and FIG. 6 is an enlarged view of portion C of FIG. 5.

As illustrated in FIGS. 1, 2A and 2B, a battery module 100 according to the present exemplary embodiment includes a battery cell stack 101 including a plurality of battery cells 110, a housing 120 accommodating the battery cell stack 101, and a pair of end plates 130 each positioned on front and rear surfaces of the battery cell stack 101.

As illustrated in FIG. 1, the housing 120 may be in the form of a metal plate in which an upper surface, a lower surface, and both surfaces are integrated. That is, in the case of the housing 120 in the form of a square tube, a space in which the battery cell stack 101 may be accommodated is formed therein, and a pair of end plates 130 is coupled to both end portions in the form of the square tube. However, the present invention is not limited thereto, and various types of housings 120 may be applied. As a possible modification, the housing 120 in a form in which the upper cover and the U-shaped frame are coupled is also possible, and is not particularly limited.

The battery cell stack 101 includes a plurality of battery cells 110 stacked in one direction, and the plurality of battery cells 110 may be stacked standing parallel to a sidewall 124 of the housing 120 as illustrated in FIGS. 2A and 2B.

The battery cell 110 is preferably a pouch-type battery cell. For example, as illustrated in FIG. 3, the battery cell 110 according to the present exemplary embodiment has a structure in which two electrode leads 111 and 112 face each other, and thus, protrude from one end portion 114a and the other end portion 114b of a battery body 113, respectively. An electrode lead included in each battery cell 110 is a positive electrode lead or a negative electrode lead, and end portions of the electrode leads 111 and 112 of each battery cell 110 may be bent in one direction, and thus, may contact end portions of electrode leads 111 and 112 of other adjacent battery cells 110. The two electrode leads 111 and 112 in contact with each other may be fixed to each other by welding or the like, and thus, an electrical connection between the battery cells 110 inside the battery cell stack 101 may be made. In addition, electrode leads aligned at both end portions of the battery cell stack 101 may be coupled to a bus bar frame (not illustrated) to be electrically connected to a bus bar mounted on the bus bar frame. The pair of end plates 130 covering the bus bar frames are provided on both open sides of the housing 120, respectively, and thus, may be coupled to the housing 120 by a method such as welding.

The battery cell 110 may be manufactured by adhering both end portions 114a and 114b of the case 114 and both side surfaces 114c connecting the end portions 114a and 114b in a state in which the electrode assembly 121 is accommodated in the battery case 114. In other words, the battery cell 110 according to the present exemplary embodiment has a total of three sealing parts 114sa, 114sb, and 114sc, and the sealing parts 114sa, 114sb, and 114sc are sealed by a method such as thermal fusion, and the other one side part may be formed of a connection part 115.

The electrode assembly 121 and an electrolytic solution may be accommodated in the battery case 114. The electrode assembly 121 may be configured in a form in which a positive electrode plate and a negative electrode plate are disposed with a separator interposed therebetween. In this case, the electrode assembly 121 may have a structure in which one positive electrode plate and one negative electrode plate are wound with a separator interposed therebetween, or a structure in which a plurality of positive electrode plates and a plurality of negative electrode plates are stacked with a separator interposed therebetween. Each of the positive and negative electrode plates may be formed as a structure in which an active material slurry is applied to an electrode current collector, in which the slurry is typically formed by stirring an active material, a conductive material, a binder, and a plasticizer in a state in which a solvent is added.

An uncoated region to which the slurry is not applied to the electrode plate may exist in the electrode assembly 121, and electrode tabs corresponding to each electrode plate may be formed in the uncoated region. In this case, the two electrode leads 111 and 112 respectively extending from a positive electrode tab and a negative electrode tab for electrical connection with an external terminal or a device may face each other, and thus, protrude at one end portion 114a and the other end portion 114b of the battery body 113, respectively.

A thermally conductive resin layer 200 may be positioned between the battery cell stack 101 and a bottom of the housing 120. The thermally conductive resin layer 200 may transfer heat generated from the battery cell stack 101 to the bottom of the battery module 100 and also serve to fix the battery cell stack 101 to the bottom thereof.

As illustrated in FIGS. 2A and 2B, a plurality of flame-retardant pads 400 may be interposed between the battery cells 110. As illustrated in FIG. 2A, the plurality of flame-retardant pads 400 may be inserted one by one whenever three to four battery cells 110 are stacked, and thus, the plurality of flame-retardant pads 400 may be disposed at equal intervals. In addition, as illustrated in FIG. 2B, the plurality of flame-retardant pads 400 may be disposed at different intervals. The arrangement of the flame-retardant pads 400 is not particularly limited, and the number and thickness thereof may be appropriately adjusted as necessary. In this way, by arranging the flame-retardant pads 400 to be spaced at equal or non-equal intervals, thermal impedance may increase when the thermal runaway occurs in the battery cells 110 in the battery module 100, thereby preventing or delaying transfer of heat between adjacent battery cells 110. In addition, the flame-retardant pad 400 may also be disposed between the battery cell 110 stacked on an outermost side of the battery cell stack 101 and the sidewall 124. When an issue such as the thermal runaway occurs within the battery module 100, the flame-retardant pad 400 may not only delay or block the transfer of heat from the corresponding battery cell to adjacent battery cells, but also absorb an expansion of the battery cell 110 to perform an expansion control.

An area of the flame-retardant pad 400 is equal to or larger than that of the electrode assembly 121 included in the battery cell 110. When the area of the flame-retardant pad 400 is formed to be smaller than that of the electrode assembly 121, a uniform pressure may not be applied to the battery cell 110, so problems such as performance degradation may occur. In particular, the flame-retardant pad 400 may serve to absorb swelling when the swelling of the battery cell 110 occurs inside the battery module 100, and when the area is smaller than the electrode assembly 121, the swelling that occurs in the portion where the flame-retardant pad 400 is not formed may not be absorbed.

As illustrated in FIG. 4, the area of the electrode assembly 121 may be determined by a length SE or the like of one side of the electrode assembly, and the area of the battery cell 110 may be determined by a length SC of one side of the battery cell. More specifically, the area of the electrode assembly 121 may be determined by an area of the positive electrode, the negative electrode, or the separator of the electrode assembly 121. In the battery cell 110, the electrode assembly 121 does not occupy the entire space inside the battery case 114, but a space for connection with the electrode leads 111 and 112 is further present. For example, the electrode assembly 121 may be about 90% of the area of the battery cell 110. In this case, in order to effectively control the swelling of the battery cell 110, at least the area of the flame-retardant pad 400 needs to be equal to the area of the electrode assembly 121 as described above. When the flame-retardant pad 400 supports an area smaller than that of the electrode assembly 121, the swelling that occurs is rather concentrated on a portion that does not correspond to the flame-retardant pad 400, and thus, the battery cell 110 may be damaged. More specifically, the area of the flame-retardant pad 400 is preferably equal to or larger than that of the negative electrode of the electrode assembly 121. For example, in the chemical reaction of a lithium ion battery, the negative electrode is designed to be wider and longer than the positive electrode because the negative electrode must receive lithium ions from the positive electrode. Accordingly, it is not preferable that the area of the flame-retardant pad 400 is smaller than the area of the negative electrode, because swelling generated during charging and discharging cannot be sufficiently absorbed.

Therefore, as illustrated in FIGS. 4 to 6, the flame-retardant pad 400 should be formed equal to or larger than that of the electrode assembly 121 included in the battery cell 110, and as a result, the swelling control performance of the battery cell 110 by the flame-retardant pad 400 may also be maintained excellently. In addition, it is possible to prevent the swelling from being concentrated in a local portion of the battery cell 110 to deteriorate the battery performance.

In addition, while the area of the flame-retardant pad 400 may also equal to or larger than that of the electrode assembly 121, it is preferably a size that does not extend to a portion where the electrode leads 111 and 112 coupled to the electrode tabs extending from the electrode assembly 121 are disposed.

When the flame-retardant pad 400 extends to the portion where the electrode leads 111 and 112 are disposed, interference occurs in the process of assembling for electrical connection between the electrode leads 111 and 112 and other components, which may not be desirable. When the flame-retardant pad 400 extends to the portion where the electrode leads 111 and 112 are disposed, it is not preferable because interference occurs in the process of assembling for electrical connection between the electrode leads 111 and 112 and other components. In addition, damage to each other may occur due to contact between the flame-retardant pad 400 and the electrode leads 111 and 112. Therefore, it is preferable that the area of the flame-retardant pad 400 is set so that the electrode leads 111 and 112 are not disposed in the portion protruding from the electrode cell 110.

The flame-retardant pad 400 may be formed of a silicone foam pad to prevent the transfer of heat and flame generated to the battery cell 110. The silicone foam pad is a foam pad with pores formed therein, and has high thermal and chemical stability, and has excellent flame retardant and thermal insulation properties. In particular, it is possible to secure better flame-retardant properties by applying a silicone foam pad made of thermosetting foamed silicone.

In addition, from the viewpoint of the swelling control of the battery cell 110 described above, the silicone foam pad is suitably applicable in that it has high elasticity (high compression resistance and high rebound elasticity) and high durability. In particular, according to the swelling of the battery cell 110, the battery cell 110 repeatedly contracts and expands. In order to withstand the repeated contraction and expansion of the battery cell 110 and prevent the battery cell 110 from being deformed, high elasticity is required. To this end, the silicone foam pad may be used. Specifically, the silicone foam pad may exert a compressive force of 10 kPA to 100 kPa in 10% to 60% of a compression range (compression force deflection (CFD)). For example, CFD 25% (ASTM D 3574) value may be 0.05-0.18 kgf/cm², as an initial value. Further, the silicone foam preferably has a long-term restoration lifespan (durability) of 10 years or more.

In the case of the silicone foam pad, it is preferable that the content of hydrocarbon is small to minimize the collapse of the structure of the battery cell 110 due to the combustion under the condition that the thermal runaway occurs in the battery cell 110. That is, as hydrocarbon is thermally decomposed into gas phases such as CO, CO₂, and water vapor by the combustion reaction when thermal runaway occurs in the battery cell, the weight loss of the flame-retardant pad may increase and the structure of the battery cell may collapse, so the content of hydrocarbon in the silicone foam pad is preferably adjusted as little as possible. In addition, it is preferable that the foam pad does not contain a halogen element in order not to generate a toxic gas during the combustion,.

An experiment was performed at a time of a voltage drop when the thermal runaway occurs for the battery module 100 to which the silicone foam pad is applied as the flame-retardant pad 400 and the battery module to which the flame-retardant pad 400 is not applied.

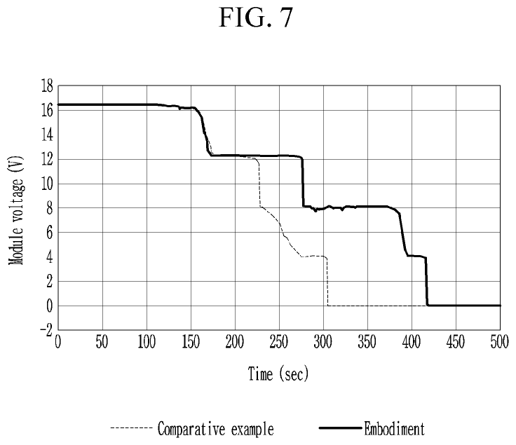

FIG. 7 is a graph illustrating results of a thermal runaway experiment for the example of the present invention and the comparative example.

In the Example, the battery module included 12 battery cells, a flame-retardant pad was applied to every 6 battery cells, and a total of two flame-retardant pads were inserted to configure the battery module. In the Comparative Example, in the same configuration, the battery module was constructed by applying a polyurethane pad instead of the flame-retardant pad. The battery module was heated by attaching a heating pad to an end of the battery module, and the thermal runaway occurred at about 140 seconds after starting heating by applying voltage to the heating plate. After that, the time point of the voltage drop of the entire battery module was measured.

As illustrated in FIG. 7, in Comparative Example, the battery module voltage became 0 at about 300 seconds, but in the Example, the voltage became 0 at about 420 seconds. That is, according to the embodiment of the present invention, it was confirmed that the delay or blocking of the transfer of heat from a cell where the thermal runaway occurred to adjacent cells was appropriately performed, and thus the time point of the voltage drop due to the thermal runaway is delayed as much as possible.

As described above, according to the exemplary embodiment, by providing the flame-retardant pad 400 between the battery cells 110 of the battery module 100, it is possible to delay or block the transfer of heat to adjacent battery cells when the thermal runaway occurs, so the safety of the battery may be improved. In addition, by making the area of the flame-retardant pad 400 equal to or larger than that of the electrode assembly 121, it is possible to prevent problems such as damage to the battery cells and electrodes and deterioration in performance/cycle-life which may be caused by the formation of non-uniform surface pressure between the battery cells.

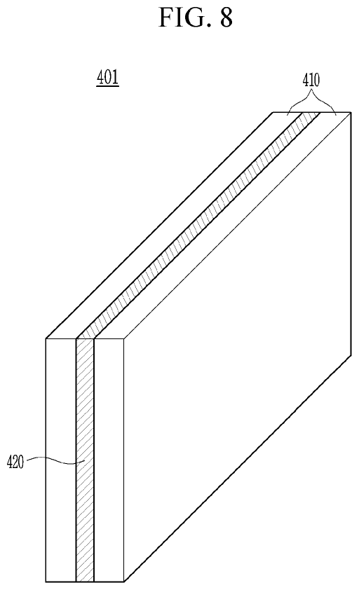

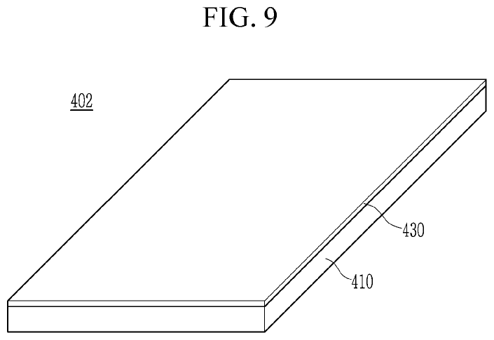

The flame-retardant pad 400 may be modified in various forms and applied to the battery module 100. Hereinafter, flame-retardant pads according to another exemplary embodiments of the present invention will be described with reference to FIGS. 8 and 9.

FIG. 8 is an illustration of a flame-retardant pad according to a second exemplary embodiment of the present invention and FIG. 9 is an illustration of a flame-retardant pad according to a third exemplary embodiment of the present invention.

As illustrated in FIG. 8, a flame-retardant pad 401 according to the second exemplary embodiment of the present invention includes two silicone foam pads 410, and a mica sheet 420 interposed between the two silicone foam pads 410. By applying the flame-retardant pad 401 further including the mica sheet 420 having excellent heat resistance between the silicone foam pads 410 as described above, it is possible to more effectively prevent the structural collapse of the silicone foam pad 410 due to the thermal decomposition under the thermal runaway condition.

As illustrated in FIG. 9, the flame-retardant pad 402 according to the third exemplary embodiment of the present invention further includes a coating film 430 formed on the silicone foam pad 410. The coating film 430 may be applied to improve process easiness and reduce a friction force between the flame-retardant pad 402 and the battery cell 110 when the battery cell stack 101 of the battery module 100 is manufactured. The coating film 430 may be attached to the silicone foam pad 410 by an adhesive or the like. The coating film 430 includes at least one of polyethylene terephthalate (PET), polyvinyl chloride (PVC), polypropylene (PP) and polycarbonate (PC), but is not particularly limited.

In another modified example, the silicone foam pad having a fine pattern formed on its surface may be used as the flame-retardant pad 400. By forming the fine pattern, it is possible to prevent foreign substances from adhering to the flame-retardant pad 400, and it is possible to obtain a desired degree of frictional force. The shape and size of the fine pattern are not particularly limited.

In another modified example, various properties may be imparted to the flame-retardant pad 400 by controlling the pores inside the silicone foam pad used as the flame-retardant pad 400. That is, when manufacturing the silicone foam pad, a ratio and size of pores may be adjusted (that is, density is adjusted) by adjusting an addition ratio of a foaming agent and a curing agent. In this case, as the density of the pores increases, the thermal insulation property may be improved, and as the density of the pores decreases, the mechanical properties may be improved.

Accordingly, it is possible to obtain a silicone foam pad having desired thermal insulation property and mechanical properties by properly adjusting the density of the pores.

In addition, by filling the pores inside the silicone foam pad with various additional materials, the physical properties of the silicone foam pad may be reinforced. These additional materials may be added to the inside of the silicone foam pad by being mixed together when the foaming agent and the curing agent are mixed to form the silicone foam pad.

For example, an inorganic refractory filler may be added to the pores inside the silicone foam pad to reinforce the heat resistance of the silicone foam pad. The inorganic refractory filler may include at least one of calcium carbonate (CaCO₃), mica, glass fiber, and mineral fiber composite.

In addition, the flame retardant filler may be further added to the pores inside the silicone foam pad so that the silicone foam pad may have flame retardant or self-extinguishing properties. As the flame retardant filler, at least one of nano-bismuth oxide, aluminum oxide nano-powder, and organic nano-clay may be used, but is not particularly limited. By adding a flame retardant filler, it is possible to have a flame retardancy suitable for underwriters laboratory (UL) standards.

Meanwhile, by filling the pores inside the silicone foam pad with extinguishing agents to allow carbon dioxide gas to be released under thermal runaway conditions, it is possible to provide a self-extinguishing function capable of suppressing the combustion reaction itself. As the extinguishing agent, at least one selected from the group consisting of inorganic carbonates, inorganic phosphates, and inorganic sulfates may be used, and the extinguishing agent is not particularly limited.

As such, according to other exemplary embodiments of the present invention, it is possible to provide a flame-retardant pad having better flame retardancy, heat insulation, and mechanical properties by reinforcing various additional physical properties of the silicone foam pad used as the flame-retardant pad. Therefore, in the case of a thermal runaway condition in the battery module, it is possible to more effectively delay or block the transfer of heat and suppress the combustion reaction.

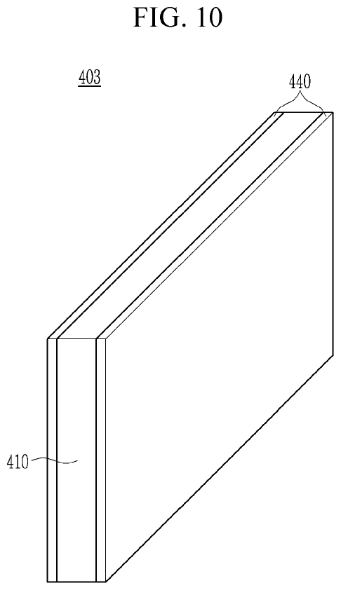

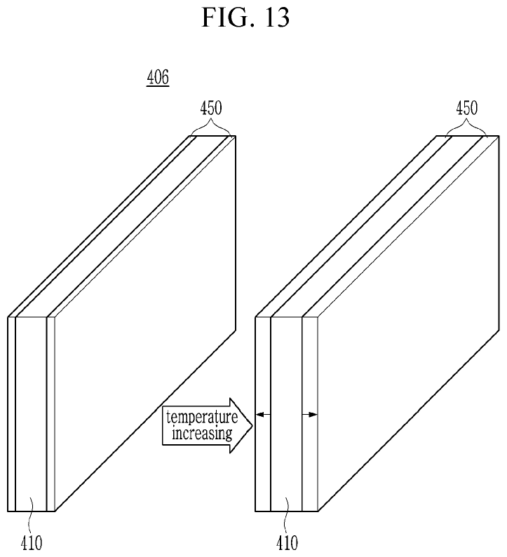

Hereinafter, flame-retardant pads according to other exemplary embodiments of the present invention will be described with reference to FIGS. 10 and 13.

FIG. 10 is an illustration of a flame-retardant pad according to a fourth exemplary embodiment of the present invention. As illustrated in FIG. 10, a flame-retardant pad 403 according to the fourth exemplary embodiment further includes at least one thermal insulation-flame retarding member 440 formed on at least one surface of the silicone form pad 410. The thermal insulation-flame retarding member 440 may prevent the flame from spreading when a flame is generated. In addition, the thermal insulation-flame retarding member 440 can prevent heat diffusion to adjacent cells by the thermal insulation performance of the thermal insulation-flame retarding member 440, even when a portion of the patter module 100 is in a high-temperature state due to thermal runaway occurring in any one cell of the battery module 100. In particular, by adding the thermal insulation-flame retarding member 440, which is made of a material different from the silicone foam pad 410, to the surface of the silicone foam pad 410, it is possible to more reliably prevent the spread of flame and heat between adjacent cells. The thermal insulation-flame retarding member 440 may be formed on any one surface or both surfaces of the silicone foam pad 410, or may be added as an inner layer of the silicone foam pad 410. However, as illustrated in FIG. 10, when the thermal insulation-flame retarding member 440 is disposed on both surfaces of the silicone foam pad 410, heat and flame generated from the battery cell can be in direct contact with the thermal insulation-flame retarded member 440, so that heat and flame can be more effectively prevented. As the thermal insulation-flame retarding member 440, at least one selected from a glass fiber reinforced pad (GFRP) and a carbon fiber reinforced pad (CFRP) may be used. As such, by using a configuration comprising at least one the insulation-flame retarding member 440 formed on the surface of the silicone foam pad 410 as the flame-retardant pad 403, it is possible to more effectively prevent heat and flame from spreading to adjacent cells when the thermal runaway occurs in any one cell.

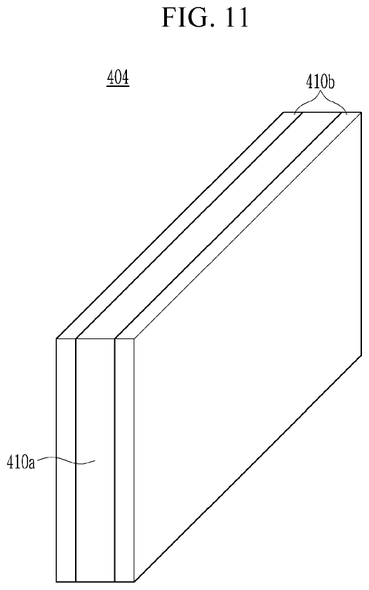

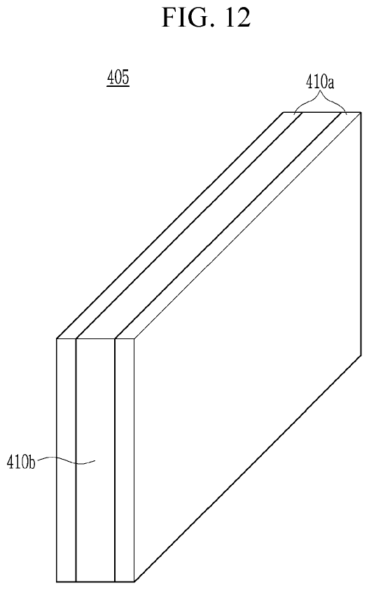

FIGS. 11 and 12 are illustrations of flame-retardant pads according to fifth and sixth exemplary embodiments of the present invention. As illustrated in FIGS. 11 and 12, the flame-retardant pads 404 and 405 according to the fifth and sixth exemplary embodiments include multilayered silicone foam pads 410a and 410b. In particular, the flame-retardant pads 404 and 405 include at least one first silicone foam pad 410a and at least one second silicone foam pad 410b. In this case, the density of the first silicone foam pad 410a is higher than the density of the second silicone foam pad 410b. The first silicone foam pad 410a and second silicone foam pad 410b have a configuration in which the first silicone foam pad 410a is disposed in the center and the second silicone foam pads 410b are disposed on both sides of the first silicone foam pad 410a, as shown in FIG. 11, or have a configuration in which the second silicone foam pad 410b is disposed in the center and the first silicone foam pads 410a are disposed on both sides of the second silicone foam pad 410b, as shown in FIG. 12. As such, by using the high-density and low-density silicone foam pads 410a and 410b together, the flame-retardant pads 404 and 405 can effectively control the expansion of the battery cell and effectively delay or block the transfer of heat. That is, the first silicone foam pad 410a having a high density is advantageous in more effectively delaying or blocking heat transfer under a thermal runaway condition, but may be somewhat disadvantageous in controlling cell expansion. However, by providing the second silicone foam pad 410b having a low density, it is possible to have a buffering effect on the expansion of the battery cell 110 and thus effectively achieve the expansion control of the battery cell 110. The density of the silicone foam pad 410a and 410b may be controlled by adjusting the size and the number of pores inside the silicone foam pad 410a and 410b, but is not limited thereto.

FIG. 13 is an illustrations of a flame-retardant pad according to a seventh exemplary embodiment of the present invention. As illustrated in FIG. 13, the flame-retardant pad 406 according to the seventh exemplary embodiment further includes at least one foaming coating layer 450 formed on at least one surface of the silicone form pad 410. The foam coating layer 450 has a property of expanding when the temperature is rapidly increased due to thermal runaway occurring inside the battery cell 110. Since the space between the cells may be expanded by this property, the flame-retardant pad 406 secures a space to thermally insulate the cells when exposed to high temperatures. Thereby the flame-retardant pad 406 may more effectively delay or block the transfer of heat. As the foaming coating layer 450, a coating of a foam material that responds to temperature can be appropriately selected and used. For example, a flame retardant including phosphorus may be used. In this case, the foaming coating layer 450 may undergo an endothermic decomposition reaction at a high temperature to cause the foaming coating layer to expand, thereby not only securing a space between cells, but also blocking or delaying heat transfer by forming a carbonized layer, which is a porous and thermally stable layer with very low thermal conductivity.

As such, according to the fourth to seventh exemplary embodiments of the present invention, it is possible to provide a flame-retardant pad that can more effectively absorb the swelling of the battery cell while having better flame retardancy, heat insulation, and mechanical properties, by adding an additional layer to the silicone foam pad used as the flame-retardant pad, or by changing the physical properties of the silicone foam pad. Accordingly, it is possible to effectively control the swelling of the battery cell as the temperature rises in the battery module, and to more effectively delay or block the transfer of heat and suppress the combustion reaction even in a thermal runaway condition at a high temperature. Meanwhile, one or more battery modules according to an exemplary embodiment of the present invention may be packaged in a pack case to form a battery pack.

The above-described battery module and battery pack including the same may be applied to various devices. Such a device may be applied to transportation means such as an electric bicycle, an electric vehicle, and a hybrid vehicle, but the present invention is not limited thereto and is applicable to various devices that can use a battery module and a battery pack including the same, which belongs to the scope of the present invention.

Although the exemplary embodiment of the present invention has been described in detail hereinabove, the scope of the present invention is not limited thereto. That is, several modifications and alterations made by a person of ordinary skill in the art using a basic concept of the present invention as defined in the claims fall within the scope of the present invention.

1. A battery module, comprising:
a battery cell stack comprising a plurality of battery cells, wherein each of the plurality of battery cells includes an electrode assembly;
a housing accommodating the battery cell stack; and
at least one flame-retardant pad interposed between at least one pair of adjacent battery cells among the plurality of battery cells or between the battery cell stack and the housing,
wherein an area of the at least one flame-retardant pad is equal to or larger than an area of the electrode assembly of each of the plurality of battery cells.

2. The battery module of claim 1, comprising:
at least two or more flame-retardant pads, wherein at least one battery cell is positioned between two adjacent flame-retardant pads.

3. The battery module of claim 2, wherein:
a spacing between the two or more flame-retardant pads is the same or different.

4. The battery module of claim 1, wherein:
the at least one flame-retardant pad includes a silicone foam pad.

5. The battery module of claim 4, wherein:
the at least one flame-retardant pad includes two silicone foam pads and a mica sheet interposed between the two silicone foam pads.

6. The battery module of claim 4, further comprising:
a coating film formed on a surface of the silicone foam pad.

7. The battery module of claim 6, wherein:
the coating film includes at least one selected from the group consisting of polyethylene terephthalate (PET), polyvinyl chloride (PVC), polypropylene (PP), and polycarbonate (PC).

8. The battery module of claim 4, wherein:
a fine pattern is formed on a surface of the silicone foam pad.

9. The battery module of claim 4, wherein:
the silicone foam pad includes an inorganic refractory filler, such that pores of the silicone foam pad are filled with the inorganic refractory filler.

10. The battery module of claim 9, wherein:
the inorganic refractory filler includes at least one selected from the group consisting of calcium carbonate (CaCO₃), mica, glass fiber, and mineral fiber composite.

11. The battery module of claim 4, wherein:
the silicone foam pad includes an extinguishing agent, such that pores of the silicone foam pad are filled with the extinguishing agent.

12. The battery module of claim 11, wherein:
the extinguishing agent is at least one selected from the group consisting of inorganic carbonates, inorganic phosphates, and inorganic sulfates.

13. The battery module of claim 4, wherein:
the silicone foam pad includes a flame-retardant filler, such that the silicone foam pad are filled with the flame-retardant filler.

14. The battery module of claim 13, wherein:
the flame-retardant filler is at least one selected from the group consisting of nano-bismuth oxide, aluminum oxide nano-powder, and organic nano-clay.

15. The battery module of claim 1, wherein:
an area of the at least one flame-retardant pad is equal to or larger than an area of a negative electrode of the electrode assembly.

16. The battery module of claim 1, wherein:
the at least one flame-retardant pad does not overlap a portion of the battery cell stack where electrode leads coupled to the electrode assembly are disposed.

17. The battery module of claim 4, wherein:
the silicone foam pad does not contain a halogen component.

18. The battery module of claim 4, wherein:
the at least one flame-retardant pad further includes at least one thermal insulation-flame retarding member formed on at least one surface of the silicone foam pad.

19. The battery module of claim 18, wherein:
the thermal insulation-flame retarding member is at least one selected from the group consisting of glass fiber reinforced pad and carbon fiber reinforced pad.

20. The battery module of claim 4, wherein:
the silicone foam pad includes at least one first silicone foam pad and at least one second silicone foam pad, and
a density of the first silicone foam pad is higher than a density of the second silicone foam pad.

21. The battery module of claim 20, wherein:
the silicone foam pad includes one first silicone foam pad and two second silicone foam pads, and
the one first silicone foam pad is disposed between the two second silicone foam pads.

22. The battery module of claim 20, wherein:
the silicone foam pad includes one second silicone foam pads and two first silicone foam pads, and
the one second silicone foam pad is disposed between the two first silicone foam pads.

23. The battery module of claim 4, wherein:
the at least one flame-retardant pad further includes at least one foaming coating layer formed on at least one surface of the silicone foam pad.

24. The battery module of claim 23, wherein:
the foaming coating layer expands as a surrounding temperature rises.

25. A battery pack, comprising:
at least one battery module of claim 1; and
a case housing the at least one battery module.
